(19) United States
(12) Patent Application Publication
(10) Pub. No.: US 2004/0259695 A1
(43) Pub. Date: Dec. 23, 2004

(54) Footrest exerciser

(76) Inventor: Venanzio Cardarelli, Plymouth, MA (US)

Correspondence Address: D. MICHAEL BURNS, 37-6 Belmont Court, Brockton, MA, 02301, US

(21) Appl. No.: 10/868,993

(22) Filed: Jun. 16, 2004

Related U.S. Application Data
(60) Provisional application No. 60/479,897, filed on Jun. 20, 2003.

(51) Int. Cl. A61H 1/00

(52) U.S. Cl. 482/79; 601/27

(57) ABSTRACT

The present invention is directed towards a footrest which can be used as an exercise and/or massaging device for a user's lower extremities. The invention is very suitable for employment with a standardized stabilizer bar present under most every airplane seat. The functional element of the invention utilizes a compressible cushion or massage devices made from lightweight materials such as plastic. The invention is mounted onto the stabilizer bar by resilient arms that are dimensioned to be snap-fitted onto the bar.

### CROSS-REFERENCE TO RELATED APPLICATION

This application is based on Provisional Patent Application Ser. No. 60/479,897, filed on Jun. 20, 2003.

### FIELD OF THE INVENTION

The invention relates generally to a footrest where an individual may simulate his/her circulation in the lower extremities. More specifically, the footrest is designed for use on an airplane.

### BACKGROUND OF THE INVENTION

Deep-vein thrombosis, or DVT, is a medical term for the formation of blood clots. Doctors and the airline industry point out that research has not conclusively linked flying to blood clots. The airlines have for the most part, left it up to passengers to ferret out information about the possible association between flying and DVT. This condition is not limited to flying, (economy class syndrome) but can also present itself after long car trips or any other situation where people are sitting in one position for a long time.

It has been known for years that a small number of people get DVT after flights, particularly long trips when passengers stay immobile for hours. At Logan International Airport in Boston, Mass., Boston Emergency Medical Services paramedics are stationed at the airport and have transported many patients with blood-clot symptoms, and made public on numerous occasions the problems that may arise particularly on long flights.

Recently, airlines have starting to warn passengers about the danger of DVT and are advising them on how to prevent it with exercise and adequate liquids. American Airlines now issues a pamphlet entitled “How to avoid blood clots while flying”. Many airlines are recruiting specialists to conduct studies on DVT and flying. Air France, as do most international flights, shows an on-flight video on stretching.

Doctors agree that people can be pro-active and wear loose fitting clothes, avoid crossing legs, avoid sleeping for more than two hours at a time, drink plenty of fluids, and watch for symptoms such as sudden swelling in one leg, cramming or tenderness in one leg, shortness of breath and rapid breathing, especially within 30 days of the flight.

It is well recognized that there is a need to provide some means for airline passengers to exercise their lower extremities while in-flight. Also, the problem may arise in other environments, such as the office place, where you have people sitting for long periods of time. The present invention seeks to provide a solution for this need.

### SUMMARY OF THE INVENTION

The present invention provides for an exerciser for the lower extremities that can be conveniently placed on an airline for use by travelers, yet out of the way so that it will not interfere with the safety or comfort of the passengers. The exerciser can be stored conveniently under each passenger seat and can be mounted therein without any modifications to the basic airplane seat specifications. It is appreciated that the same mounting system can be employed with any seat, such as chairs in an office environment.

The present invention provides an aid to the circulation and activation of the venous pump to provide direction to the blood flow.

The present invention provides a massaging type experience and maintenance of muscle tone, in addition to helping decrease blood pressure in the power extremities, thereby decreasing leg swelling and fatigue of feet.

An embodiment of the invention provides a footrest exerciser which snap-fits onto a stabilizer bar that is beneath every airplane seat. The footrest exerciser can be floor mounted or raised off the floor, utilizing a mounting portion and a platform portion. The platform portion is capable of supporting compression material that is made of a lightweight depressible material. Other modifications may utilize a hollow construction to reduce weight.

In another modification of the invention, the footrest platform is elevated off the floor.

An object of the invention is to massage as well as exercise the lower legs. The present invention may be modified to include depressible projections for massaging the feet.

A primary aspect of the invention is the ease of clipping the exerciser to a standardized bar located beneath the user's seat.

### BRIEF DESCRIPTION OF THE DRAWINGS

FIG. 1 is an expanded view of the base construction of the invention.

FIG. 2 is a side cross-section view of the completed invention of FIG. 1 that is friction-fitted to a standard bar beneath the passenger seat of an airplane.

FIG. 3 is a side view of FIG. 1, which further includes a removable covering.

FIG. 4 is a side view of FIG. 1 that includes a massage type apparatus.

FIG. 5 is a side view of an embodiment designed to be raised off the floor.

FIG. 6 is a side view of another modification of the invention.

FIG. 7 is a side view of a modification of the invention having the ability to slide on and off the bar.

FIG. 8 is a side view of a modification of the invention having means to clip on and off the bar.

FIG. 9 is a pictorial front view of the embodiment of FIG. 7 therein.

### DETAILED DESCRIPTION OF THE INVENTION

Every time a person moves their legs, they compress the muscle against the fasciae and the fasciae against the skin so that the veins of the legs are compressed and the blood tends to flow away from the areas of compression. Veins of the lower extremities have numerous valves thus arranged so that the direction of blood flow can only move towards the heart. Consequently, every time a person moves their legs or even tenses their muscles, a certain amount of blood is propelled towards the heart and the pressure in the veins is lowered. This pumping action is called the “venous pump” or muscle pump, and it is efficient enough so that the venous pressure in the feet of a walking adult remains less than 25 mm Hg. It is advisable that in long airplane flights, a passenger should get up and walk around frequently to keep those pressures low and keep their blood flowing properly. Unfortunately, airplanes are not designed for the passengers to take walks.

For convenience and simplicity the discussion of the footrest exerciser in this specification is generated towards use on an airplane, however it is obvious that the same construction and application may be employed on any chair having a mounting bar provided beneath it.

One of the consequences of not getting some movement in the lower extremities is that if the venous pump is not working, people tend to become columns of blood. The blood pressure having been increased, may lead to edema and swelling, and as a result blood volume diminishes. The important thing is for people to keep moving, thereby creating blood flow.

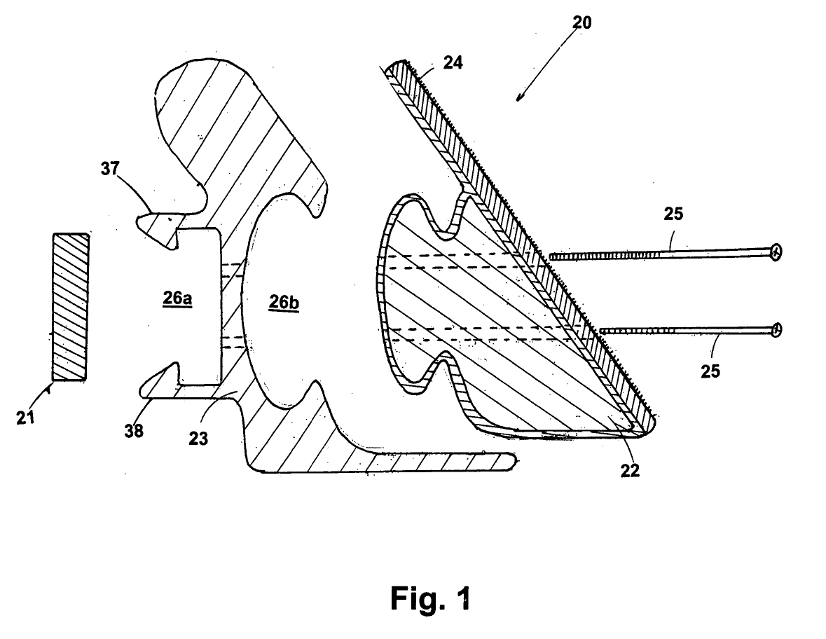

The present invention, as referenced in FIGS. 1 to 9, depicts a combination footrest exerciser and massager that can be easily attached to a standardized bar, which for this embodiment is found under virtually every airplane seat. The invention is designed to be friction-fitted, supplemented by tightening screws, to the bar. The bar measurements and configuration are standard throughout the airline industry and the bar is located directly under the passenger's seat. The invention is not limited to the airplane industry, but can be utilized on any chair with the addition to the chair of a standard sized bar. One embodiment is shown on FIGS. 1 to 3 wherein a footrest exerciser 20 is attached to a stabilizer bar 21 that is located beneath a passenger's seat (not shown). The footrest exerciser 20 is primarily of a two piece construction having a platform portion 22 and a mounting portion 23. The mounting portion 23 has a pair of openings, a rear opening 26a and a front opening 26b. The rear opening 26a defined therein by upper and lower resilient arms 37 and 38 which are dimensioned and configured so as be snap-fitted onto the stabilizer bar 21, which in he airplane industry is of a standardized dimensions. The platform portion 22 has a size and configuration to be friction-fitted into the front opening 26b of the mounting portion 23 and may be optionally reinforced by a plurality of threaded screws 25. A layer of hook and loop fastening material, such as that supplied under the trade name Velcro®, may be applied on the surface 24 of the platform portion 22 to allow for attachment of a functional element which in the example shown in FIGS. 1 to 3, is a compressible material 27. It is essential that means are provided for the ease of placement and removal of the depressible material 27, because on an airplane these depressible materials 27, or coverings for them, would have to be replaced in a limited amount of time. The depressible material 27 may be removed and either discarded or washed for repeated use. An option would be to have a disposable cover which would slide on and encase the depressible material 27 and then slipped off for disposing. This embodiment of the invention is designed such that is partly supported by the floor. The exerciser 20 is to be made of lightweight metals or plastics. Weight is obviously a major factor, as weight of a significant number of footrest exercisers 20 could substantially increase the payload weight of an aircraft. Thus for use such as on an airplane, the materials preferably are lightweight plastics, and the construction of the mounting portion hollow if possible. A two piece embodiment allows for the removal of the platform portion 22 without having to remove the mounting portion 23. This would give the airline the option of washing the platform potion 22 covering or discarding it.

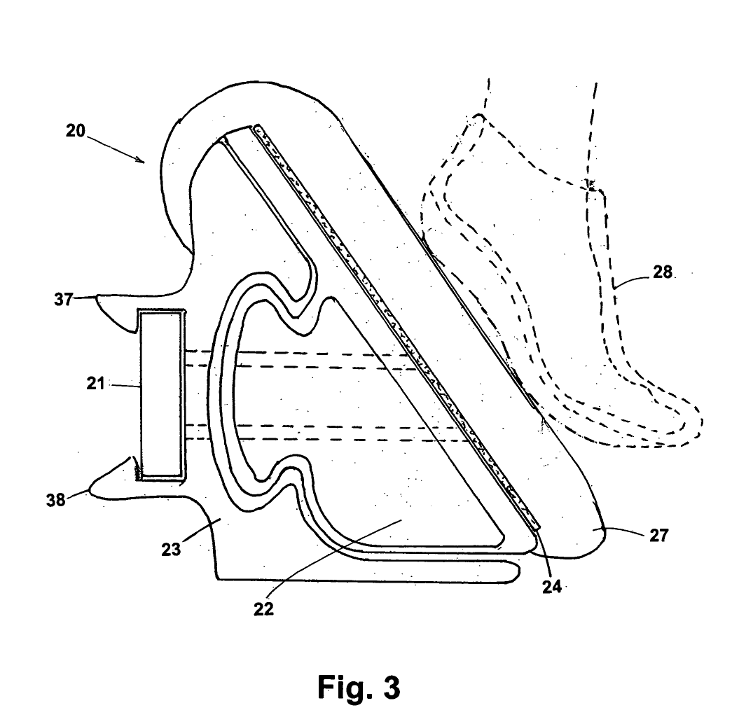

The invention as depicted by FIG. 3 shows the platform portion 22 is covered with the depressible material 27 (which is the functional element of the invention) as discussed above. The foot 28 action begins with a toe rise (metatarsal to toe rise position). This position activates or is made possible by muscles of the lower extremities of which the calf muscle is the most important. This position also elevates the knee and moves the thigh above the seat. On depressing the depressible material 27, the knee level is lowered and the thigh is depressed against the seat. The act of making the toe rise and thereby depressing the material 27 involves muscle movement, and therefore the muscle pump is activated and blood flow is improved. Blood flow improves also by the compressive effect it has on the thigh as well, thereby propelling blood towards the heart. When the action of positioning the foot occurs, work is required. When the functional element 27 (depressible material) is fully depressed, the tendency of the material is to return to its normal state, and the passenger can further take advantage of this by releasing the pressure slowly to allow the foot to return to its initial position. This slow release of pressure creates a state of tension in the calf muscle, which keeps the venous pump working well, and allows enough time for the blood to be expelled in a direction towards the knee. The slow re-activation will allow blood to flow and for the muscle pump to go into effect. The blood is expelled due to a contractual phase. The relaxation phase of the muscle contraction is the filling phase.

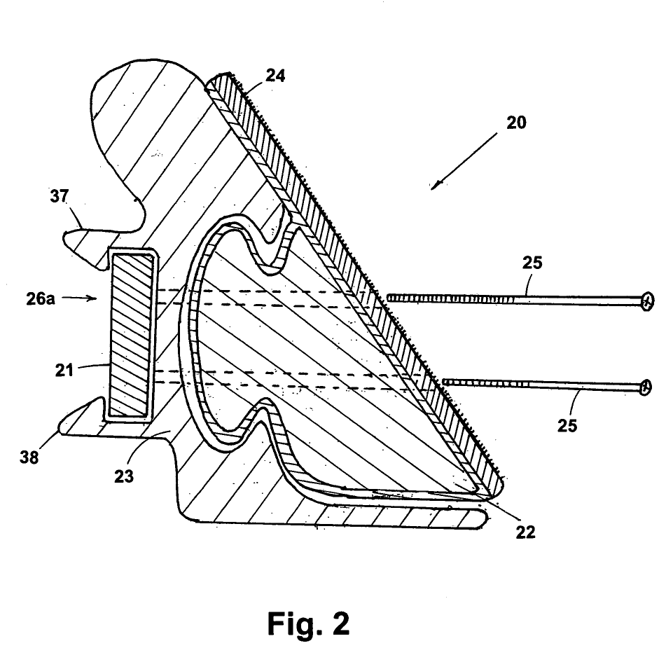

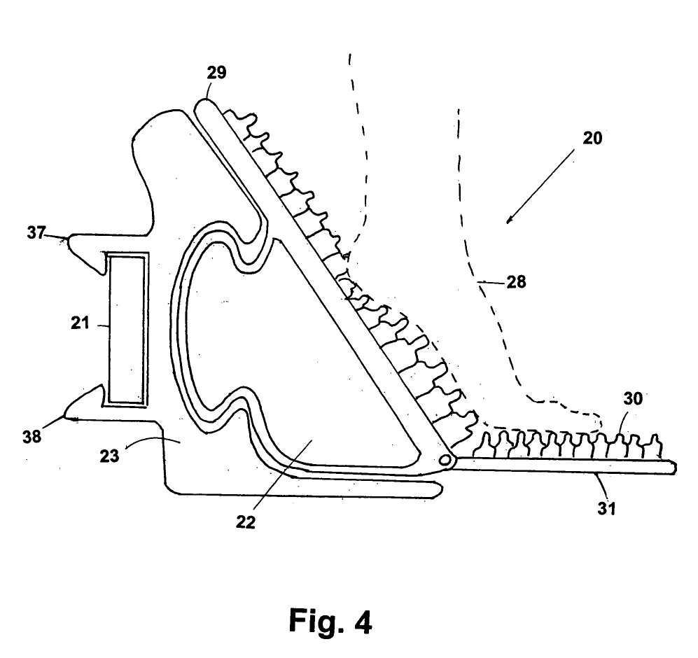

FIG. 4 depicts another embodiment of the footrest exerciser 20, wherein the platform portion 22 incorporates a massaging device 29, whereby the passenger may get a foot massage in additional to exercising his/her legs. The top surface of the massaging device 29 is enhanced by a plurality of raised projections 30 that are depressible. By removing one's shoes, and placing his/her feet on the projections 30, one may experience a massaging effect. Included in this modification is an extension section 31 that can be an inclined unit supported by the floor. The massaging device 29 may also be a separate piece that is attached by the hook and loop type fastener to the platform 22 of FIG. 2, similar in manner that the depressible material shown in FIG. 3 was attached.

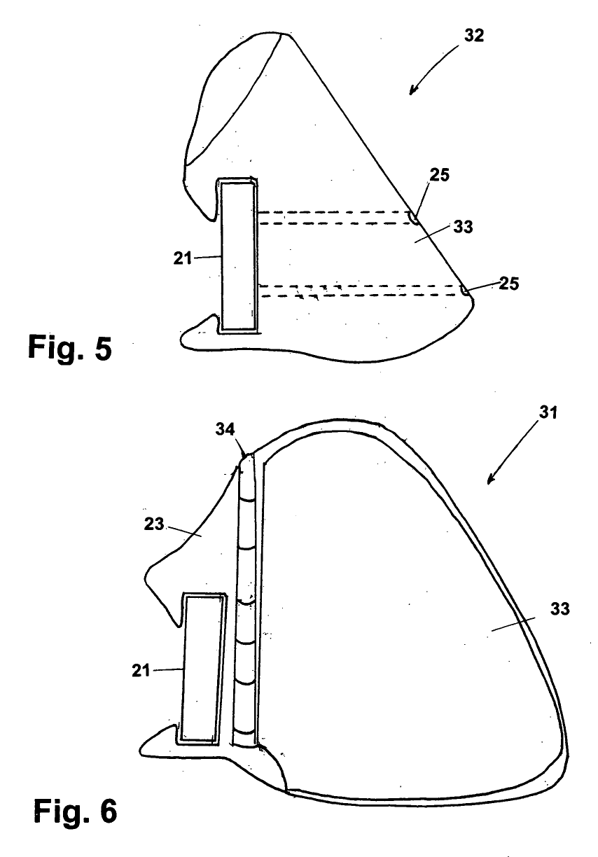

A modified housing unit 32 is illustrated by FIG.5, wherein a raised one-piece footrest exerciser is incorporated. This embodiment includes a depressible cushion 33 that may be covered by a washable, or disposable material (not shown) and also which may be attachable by a hook and loop fastener (not shown). In this arrangement the entire unit 32 is snap-fitted to the bar 21, and the entire unit is in a raised position off of the floor. As in other embodiments, multiple screws 25 may be used to secure the unit 32 to the bar 21. The heel of the passenger would be doing the pressing into the depressible cushion 33 and the pressure would be a back and down motion.

It may be preferable to have the mounting portion 23 and the depressible cushion 33 easily removable from each other. The mounting portion of FIG. 6 illustrates another embodiment wherein the exerciser is raised off the floor and utilizes a plastic or metallic insert through a channel 34 to stabilize the whole functional element. Functional elements may include massage units, brushes, exercise pieces, all of which may utilize various surface textures.

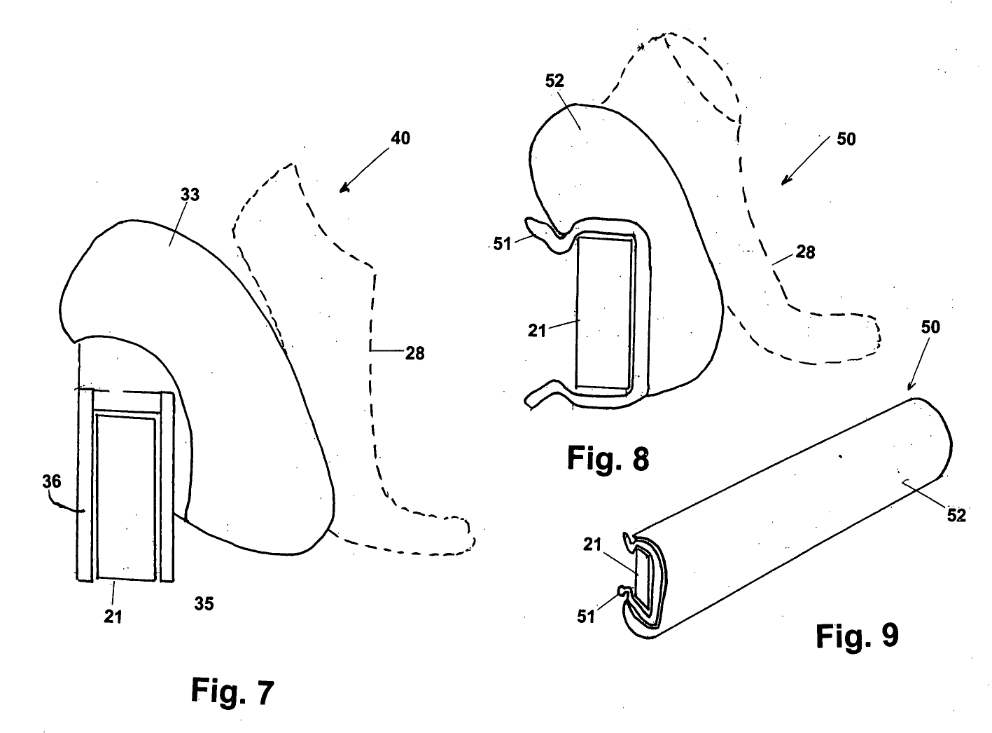

FIG. 7 shows another embodiment 40 that is raised off the floor. This embodiment has a three-sided housing for sliding over or onto the bar 21, and can be passive or movable. The housing 35 adapted to be slid over the bar 21 can be made from a moldable plastic. For ease of placement, the housing 35 may have a posterior leg 36 that may be lifted and then returned to friction lock with the bar 21. A depressible cushion 33 covers the housing 35 and the cushion 33 may be encased with a cover that can be either washable or disposable.

As described in FIGS. 8 and 9, a basic embodiment of the invention incorporates a clip-on assembly 50, which utilizes an easy clip-on and clip-off design. The clip 51 has enough resiliency so as to snap over the bar 21, and could be made from plastic or metal material. The depressible material 52 or other functional elements that may be attached are in this embodiment designed to be off the floor to permit easy cleaning for the maintenance crew. The depressible material 52 may extend along the entire length of the bar and may be attached by pulling over the clip 51 or may be fastened by hook and loop material.

The present invention does not interfere with a passenger walking in or out of their seat. It is out of the way, small and light in weight. The materials of construction are a fire retardant and will not emit noxious fumes if it did burn. The footrest must be noiseless so as not to interfere with each passenger's peace and quiet, which is why the footrest is limited in movable parts.

When in a horizontal position such as in first class seats, the blood returning to the heart flows easily and evenly. The hydrostatic pressure as a measurement taken at the great saphenous vein at the ankle is 11.7 mm Hg. As the person sits up, a column of blood is created which greatly increases the problem of returning the blood to the heart. The pressure measured at the same location is 86.8 mm Hg at a “standing still” position. It will vary in the economy class, where the sifting position is 56 mm Hg. Naturally, this pressure may vary as to the physical status and age of the individual.

While there has been shown the preferred and alternate embodiments of the present invention, it is to be understood that the invention may be embodied otherwise than is herein specifically shown and described, and that within said embodiments, certain changes may be made in the form and arrangements of the elements without departing from the underlying ideas or principles of this invention as set forth in the claims appended herewith.

I claim:

1. A footrest exerciser in combination with a stabilizer bar located beneath a user's seat, the footrest exerciser comprising:
a mounting portion having means for attaching to the stabilizer bar;
a platform portion dimensioned and sized to be friction-fitted into a front opening defined in the mounting portion; and
the platform portion having a surface supporting a functional element for exercising the user's feet and legs.

2. The footrest exerciser according to claim 1, wherein the functional element is attached by a hook and loop fastening material.

3. The footrest exerciser according to claim 1, wherein the attaching means comprises a rear opening defined by upper and lower resilient arms dimensioned and configured to allow the rear opening to be snap-fitted onto the stabilizer bar.

4. The footrest exerciser according to claim 1, wherein the attaching means is made from lightweight plastic or metal material.

5. The footrest exerciser according to claim 1, wherein the stabilizer bar is located beneath an airplane seat.

6. The footrest exerciser according to claim 2, wherein the functional element is a depressible cushion.

7. The footrest exerciser according to claim 2, wherein the functional element is encased by a removable cover.

8. The footrest exerciser according to claim 1, wherein the functional element includes a massaging device that incorporates a plurality of raised depressible projections for massaging and exercising the user's feet.

9. The footrest exerciser according to claim 1, wherein the footrest exerciser further includes at least one threaded screw for securing the exerciser to the stabilizer bar.

10. A footrest exerciser in combination with a stabilizer bar located beneath a user's seat, the footrest exerciser comprising:
a one-piece housing unit having means for attaching to the stabilizer bar; and
a depressible cushion for exercising the user's feet.

11. The footrest exerciser according to claim 10, wherein the housing unit includes the depressible cushion being covered by a disposable material.

12. The footrest exerciser according to claim 10, wherein the attaching means comprises a rear opening defined by upper and lower resilient arms dimensioned and configured to allow the rear opening to be snap-fitted onto the stabilizer bar.

13. The footrest exerciser according to claim 12, wherein the attaching means is made from lightweight plastic or metal material.

14. The footrest exerciser according to claim 10, wherein the attaching means includes a clip-on assembly wherein a clip has sufficient resiliency to allow it to be clipped over or slid onto the stabilizer bar.

15. The footrest exerciser according to claim 14, wherein the clip is of a size to cover the entire length of the stabilizer bar.

16. A footrest exerciser in combination with a stabilizer bar located beneath a user's seat, the footrest exerciser comprising:
a housing unit having means for attaching to the stabilizer bar;
the attaching means includes a three-sided housing for sliding onto the stabilizer bar, the housing having a posterior leg that can be lifted and returned to friction lock the housing to the stabilizer bar; and
a depressible cushion covering the housing for exercising the user's feet.

17. The footrest exerciser according to claim 16, wherein the attaching means is made from lightweight plastic or metal material.

18. The footrest exerciser according to claim 16, wherein the stabilizer bar is located beneath an airplane seat.

19. The footrest exerciser according to claim 16, wherein the depressible cushion is covered by a disposable material.
